(19) United States
(12) Patent Application Publication
(10) Pub. No.: US 2005/0218145 A1
(43) Pub. Date: Oct. 6, 2005

(54) Food container for freezing and brining

(76) Inventor: David Holley, Perry, GA (US)

Correspondence Address: Richard C. Litman;LITMAN LAW OFFICES, LTD., P.O. Box 15035, Arlington, VA, 22215, US

(21) Appl. No.: 10/814,158

(22) Filed: Apr. 1, 2004

(51) Int. Cl. A47J 39/00; A47J 41/00; B65D 43/14; B65D 83/72; B65D 81/38; B65D 88/74

(52) U.S. Cl. 220/592.01

(57) ABSTRACT

A food container comprises an outer container, an outer lid, an inner container, and an inner perforated lid. The inner container is perforated on at least one side and has a plurality of spacing tabs extending away from an outer surface of its wall to engage an interior surface of the wall of the outer container to provide a predetermined gap between the inner container and said outer container. The inner container is enclosed by a perforated lid having a continuous lip along its perimeter adapted to engage the rim of the inner container.

### BACKGROUND OF THE INVENTION

1. Field of the Invention

The present invention relates to a system and method for storing food. In particular, the invention relates to a container for freezing and/or brining food while submerged in a container of aqueous solution.

2. Description of the Related Art

Long-term storage of food is a necessity for many individuals. Hunters and fishermen, as well as individuals who purchase food in bulk, need to be able to store food for a long period of time without degradation. Unfortunately, simply freezing foods is not always the ideal solution. One common problem with freezing foods is sublimation of frozen water from the food. Commonly referred to as “freezer burn,” it alters the texture and flavor of food, sometimes rendering it inedible.

To prevent freezer burn, it is known to store food in a vacuum or tightly wrapped in plastic. However, these techniques are not perfect and are not reliable. Even where food is in a tightly sealed package, such as a freezer storage bag, moisture sublimates from within the food and deposits on the inside surface of the storage bag or elsewhere in the container. Vacuum storage reduces freezer burn, but is not reliable over long periods of time, is inconvenient, and is often unavailable.

It is also known to freeze food while submerged in water, but this can be a messy and unreliable. Water expands as it freezes, so a container must be able to accommodate this expansion. Furthermore, some food will float in water, so there must be a way to hold it down under the surface.

It is also known to brine or marinate foods to improve moisture content and flavor prior to cooking. Background information regarding brining is available, for example, in an article entitled, “Brining”, by Derrick Riches, 2004, http://bbq.about.com/cs/barbequetips/a/aall2000b.htm Brining generally requires that the food be completely submerged in brine for anywhere from 30 minutes for shrimp to 24 hours for a 12 pound turkey. To ensure that food stays completely submerged, it is often placed in a container such as a pot or bowl with a weight placed on top of the food to weigh it down. This can be messy and awkward. Consumers need a convenient container for freezing and brining food that ensures that all parts of the food remain submerged.

U.S. Pat. No. 2,656,640, issued Oct. 27, 1953 to Johnson et al., discloses a live bait container comprising an outer cylindrical container adapted to receive an inner basket made of wire screen. This device is not analogous to a container for freezing food. It not stackable and has no mechanism for sealing the inner container or outer container, and does not provide any means that would ensure submersion of food.

U.S. Pat. No. 4,548,852, issued Oct. 22, 1985 to Mitchell, discloses a food package that provides a modified atmosphere for perishable foods when refrigerated, and a mechanism for withdrawing that atmosphere prior to freezing. It is not stackable and no provision is made for submerging food in water prior to freezing.

U.S. Pat. No. 5,266,763, issued Nov. 30, 1993 to Colombo, discloses a container for microwaving foods comprising an inner container made from paper, an outer, more rigid container made of plastic. A lid is also provided for sealing the outer container. However, it is not stackable, the inner container is not reusable or porous for easy submersion into water and it has no lid of its own to ensure that food is so submerged.

U.S. Pat. No. 6,020,013, issued Feb. 1, 2000 to Kozma, discloses a storage bag having two spaced-apart zip-seals. In use, the space between the seals are filled with water to eliminate any possibility of ambient air entering the interior of the storage bag. This invention, while being directed to the problem of freezer burn, is not as effective in preventing freezer burn as water submersion.

None of the above inventions and patents, taken either singly or in combination, is seen to describe the instant invention as claimed. Thus a food container for freezing and brining foods solving the aforementioned problems is desired.

### SUMMARY OF THE INVENTION

A food container comprises an outer container, an outer lid, an inner container, and an inner perforated lid. The inner container is perforated on at least one side and has a plurality of spacing tabs extending away from an outer surface of its wall to engage an interior surface of the wall of the outer container to provide a predetermined gap between the inner container and said outer container. The inner container is enclosed by a perforated lid having a continuous lip along its perimeter that is adapted to engage the rim of the inner container.

### BRIEF DESCRIPTION OF THE DRAWINGS

FIG. 1 is a perspective view of an exemplary food container for freezing and brining.

FIG. 2 is an exploded view of the food container shown in FIG. 1.

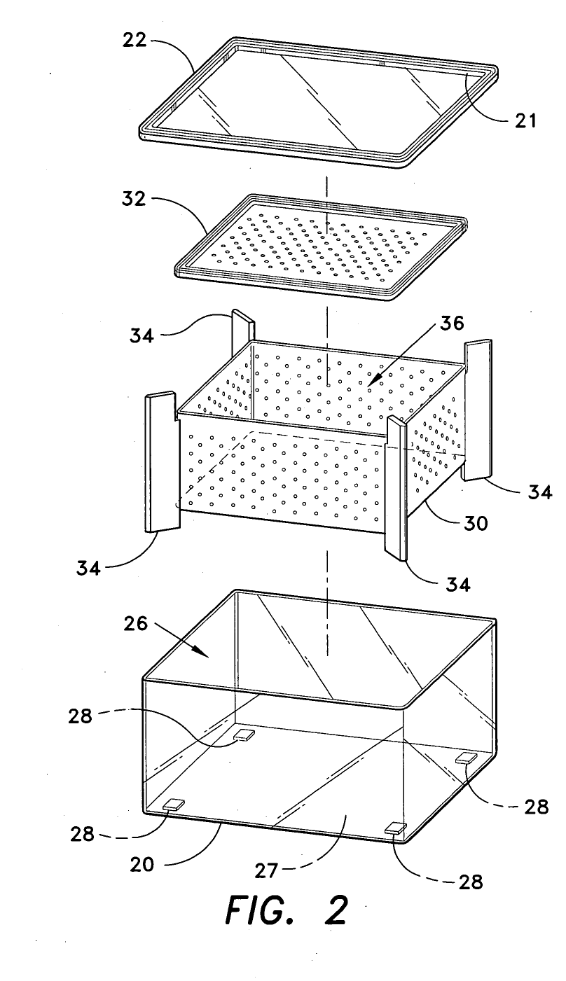

FIG. 3 shows a several of food containers as shown in FIG. 1 in a stacked relationship.

Similar reference characters denote corresponding features consistently throughout the attached drawings.

### DETAILED DESCRIPTION OF THE PREFERRED EMBODIMENT

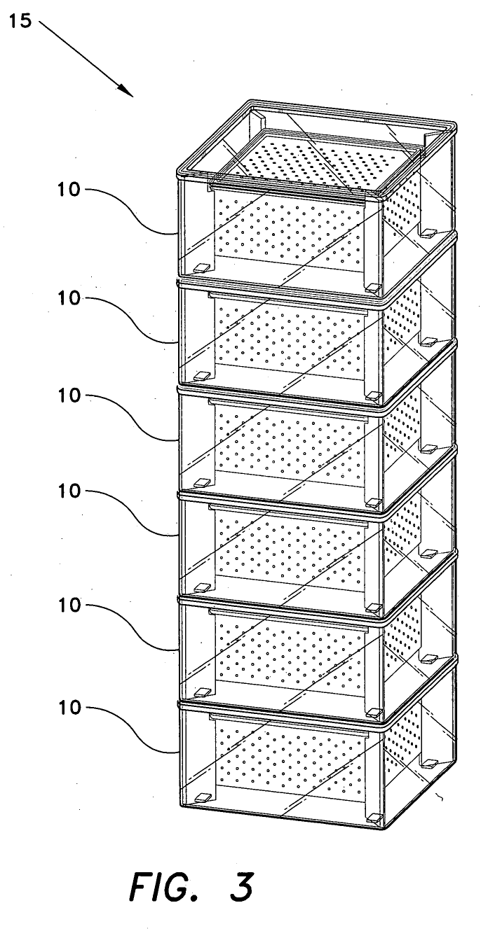

Referring now to the several figures, an exemplary food container shown generally at 10 includes an outer container 20 and an inner container 30. Outer container 20 has a lid 22 that encloses interior 26 thereof and seals against fluid exchange between interior 26 of outer container 20 and its environment. Outer container 20 includes feet 28 formed into a bottom thereof. Said feet 28 nest within lip 21 of lid 22 permitting a plurality of containers 20 to stack as shown in FIG. 3. Alternatively, in place of feet 28, the bottom of outer container 20 may be formed to nest in lip 21 of lid 22 as is generally known.

Outer container 20 is preferably generally cuboid, also referred to as rectangular parallelepiped shaped, e.g., brick-shaped, although other shapes are possible. Note that shapes having slightly sloped sides (bowl-shaped) and rounded corners are contemplated and should be included in the phrase, “generally cuboid”. It is sized to be slightly taller, wider, and deeper than inner container 30, which may be provided in various sizes such as one quart (0.9 l), two quart (1.9 l), and four quart (3.8 l) sizes. For example, outer container 30 may have about 1¼ inches (3 cm) clearance on all sides, including the top and bottom. For marinating, a shallower dish may be preferred with less or no clearance between the bottom of the inner container and the bottom of the outer container.

Preferably, outer container 20 is transparent, and strong enough to carry weight of at least two additional water-filled containers in stacked relation as shown in FIG. 3. However, outer container 20 must be flexible enough to seal with lid 22 and endure deformation caused by the expansion of water upon freezing. If necessary, strengthening ribs (not shown) may be added in a manner well understood in the art to further enhance load-carrying capacity of outer container 20. Any number of polymeric materials that are well known in the field of food storage that have suitable properties of transparency, elasticity, strength, and chemical inertness, may be employed.

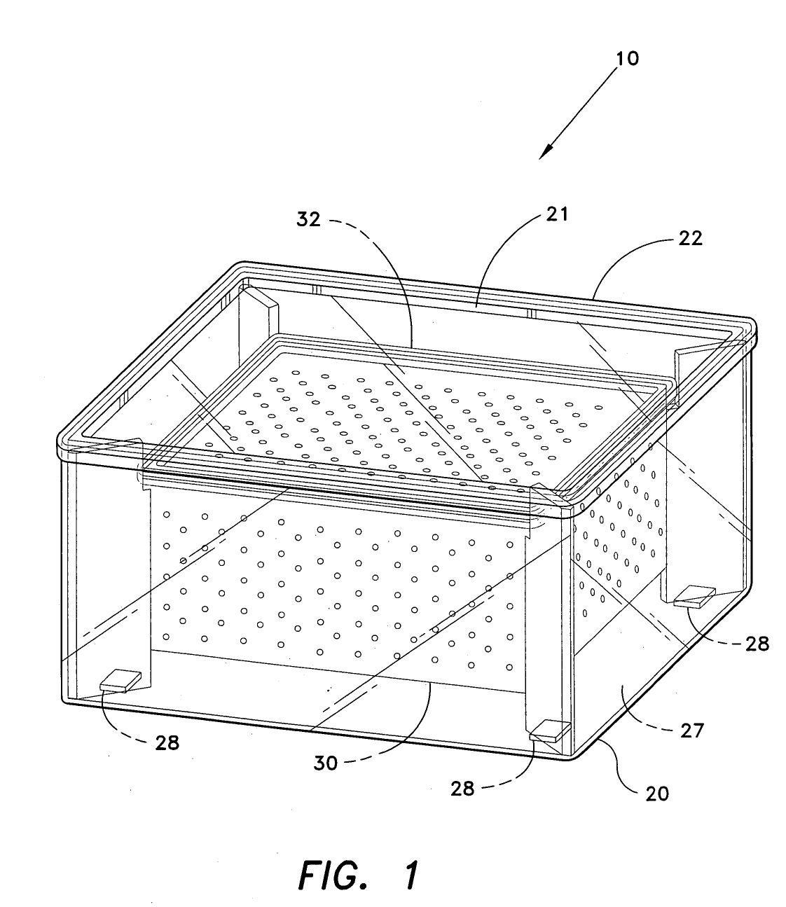

Inner container 30 is placed within outer container 20 as shown in FIG. 1 and may be formed of the same material as outer container 20 or other material. Since inner container 30 does not carry the weight of containers stacked on top food container 10, inner container 30 need not be as strong as outer container 20.

Inner container 30 includes spacing tabs 34 to ensure a gap on all sides of inner container 30, including the bottom. As mentioned above, an exemplary gap size is about 1¼ inches (3 cm). Tabs 34 extend out from each corner of inner container 30 to the inside corners of outer container 20 to center inner container 30 within outer container 20 as shown in FIG. 1. In addition, tabs 34 extend above and below inner container 30 to ensure space above and below inner container when it is placed in outer container 20. Thus, inner container 30 is maintained in a spaced relation from all interior sides of outer container 20, including the top.

Lid 32 includes a lip that engages a rim of inner container 30 so that it is removably attachable thereto. Lid 32 operates to keep food in interior 36 of inner container 36. Container 30 is perforated at least on one side, but may be perforated on all sides, including the bottom, with any number of perforations 38 sized to allow water to flow through and yet retain food in interior 36. Perforations 38 may be about 1/4 inch (6 mm) in diameter. Lid 32 is also perforated to reduce the possibility of trapped air.

In use, raw fish, meats, or vegetables are inserted in interior 36 of inner container 30. Lid 32 is fixed over inner container 30 to prevent escape of food from interior 36. Inner container is placed into interior 26 of outer container 20.

For brining, outer container 20 is filled with salt-water such that inner container 30 (and therefore the food) is completely submerged. If the food is simply to be frozen, plain water may be used, although a combined freezing/brining process may be achieved by using salt-water, so long as the amount of added salt is not so much that the freezing temperature of the resulting solution is at or below the temperature of the freezer to be used. This generally will not be a problem. For example, a 10% saltwater solution will reduce the freezing temperature by only about 11° F. (6° C.).

Food container 10 can also be used for marinating foods. In this case, any number of marinades, generally having an acidic content from wine, vinegar, or fruit juices are used for tenderizing and flavoring the meat. Spices and fruit juices, sugar, and/or other ingredients may similarly be added to a brine solution for brining or brining/freezing.

Lid 22 is then sealed to outer container 20, and the food is ready to be placed in a refrigerator for brining or freezer for storing. Food frozen submerged in water can survive several years or longer without any noticeable effects. Food frozen in saltwater will be “pre-brined” upon thawing.

It is to be understood that the present invention is not limited to the embodiment described above, but encompasses any and all embodiments within the scope of the following claims.

1. A food container comprising:
an outer container having a bottom and a continuous wall extending up to a rim;
an outer lid adapted to seal an interior of said outer container from an exterior thereof;
an inner container comprising a bottom and a continuous wall extending up from said bottom to a rim, one of said bottom and said wall being perforated, said inner container further comprising a plurality of spacing tabs extending away from an outer surface of said continuous wall, said spacing tabs-engaging an interior surface of said wall of the outer container thereby providing a gap between the inner container and said outer container; and
an inner perforated lid adapted to engage said rim of said inner container.

2. The food container according to claim 1, wherein said spacing tabs are vertically oriented.

3. The food container according to claim 2 wherein said spacing tabs extend up to maintain said inner container a predetermined distance below said outer lid during use.

4. The food container of claim 1 wherein said spacing tabs extend up to maintain said inner container a predetermined distance below said outer lid during use and said spacing tabs extend down to maintain a predetermined bottom gap between said bottom of said inner container and said bottom of said outer container.

5. The food container of claim 4 wherein said gap between said inner container and said outer container is approximately the same on all sides, including above and below said inner container.

6. The food container of claim 5 wherein said gap is about 1¼ inches.

7. The food container of claim 1 wherein said spacing tabs are formed integrally with said inner container.

8. The food container of claim 1 wherein said inner container is generally cuboid and each of said spacing tabs extends out from each of four corners formed by said continuous wall of said inner container, said tabs being shaped so that, when said inner container is placed within said outer container, a distal end of each spacing tab engages said interior surface of said outer container at a corresponding corner of said outer container.

9. The food container of claim 1 wherein said inner container is perforated on all sides, including said bottom.

10. A perforated food container, comprising:
a container having a generally rectangular bottom and four continuous sides extending up from said bottom to a rim, said container being perforated on at least one of said sides and bottom;
a perforated lid engageable with said rim for retaining food in said container, and
a plurality of spacing tabs extending out from said sides, said spacing tabs in all directions to provide a gap between said container and any larger container within which it is placed.

11. The perforated container of claim 10 wherein said spacing tabs extend out from each oft four corners formed by said four sides at about a 45° angle to each of said sides.

12. The perforated container of claim 10 wherein said gap is about 1¼ inches.
